(19) United States
(12) Patent Application Publication
(10) Pub. No.: US 2013/0179782 A1
(43) Pub. Date: Jul. 11, 2013

(54) Apparatus And Method For Embedding Links

(71) Applicants: Hubert Newman, Ottawa (CA); Matthew Mcdonald, Ottawa (CA); Patti Vanbruggen, Kemptville (CA)

(72) Inventors: Hubert Newman, Ottawa (CA); Matthew Mcdonald, Ottawa (CA); Patti Vanbruggen, Kemptville (CA)

(73) Assignee: ALCATEL-LUCENT CANADA INC., Kanata (CA)

(21) Appl. No.: 13/346,101

(22) Filed: Jan. 9, 2012

(51) Int. Cl. G06F 3/01

(52) U.S. Cl. 715/716

(57) ABSTRACT

In one embodiment, the apparatus for embedding links includes a reproducing unit configured to receive a data stream and display at least one object of the data stream on a display screen of a device. The apparatus further includes a processing unit configured to activate a link associated with a displayed object based on linking information. The linking information includes activation information and destination information. The activation information indicates a period of time when the link is activated. The destination information includes at least one of address information that points to additional information on a remote server and launch information that specifies an application to be launched on the device. The processing unit is configured to display the additional information on the display screen or launch the application upon user selection of the activated link.

### BACKGROUND

The streaming of video such as movies and television shows is dramatically increasing with the use of mobile telephones, tablet computers, and personal computers. In some conventional methods, in order to enhance the user experience, a link may be added to the displayed video, which links to another video. When the link is selected by the user, the video specified in the link will be displayed. The link will appear for a specified period of time at a specified area of the screen. However, conventional links are tied to videos of the same server.

Another conventional method allows the removal of the limitation that the links not link outside the same server, but these links are limited such that the links always remain visible on a user screen, and in the same location.

### SUMMARY

The embodiments relate to an apparatus and/or method for embedding links.

In one embodiment, the apparatus for embedding links includes a reproducing unit configured to receive a data stream and display at least one object of the data stream on a display screen of a device. The apparatus further includes a processing unit configured to activate a link associated with a displayed object based on linking information. The linking information includes activation information and destination information. The activation information indicates a period of time when the link is activated. The destination information includes at least one of address information that points to additional information on a remote server and launch information that specifies an application to be launched on the device. The processing unit is configured to display the additional information on the display screen or launch the application upon user selection of the activated link.

In one embodiment, the remote server is different from a server that transmitted the data stream received by the reproducing unit.

In one embodiment, the linking information further includes area information that defines an area on the display screen where the link is activated. The processing unit is further configured to activate the link in the area of the display screen included in the area information.

In one embodiment, the activation information includes start information that indicates a start time when the link is activated and stop information that indicates a stop time when the link ceases to be activated.

In one embodiment, the linking information includes geographically sensitive information that indicates that the additional information is location sensitive. The processing unit is configured to transmit location information of the device to the remote server associated with the additional information upon user selection of the activated link.

In one embodiment, upon user selection of the activated link, the reproducing unit is configured to pause a display of the data stream.

In one embodiment, the reproducing unit is configured to un-pause the display of the data stream after the user performs at least one action.

In one embodiment, the processing unit is configured to activate a plurality of links. Each link is associated with a different displayed object based on the linking information.

In one embodiment, the additional information is one of advertisement information, biographical information associated with the displayed object and information associated with a content of the data stream.

In one embodiment, the apparatus further includes a touch screen user interface for receiving the user selection.

In one embodiment, the apparatus further includes a pointing device user interface for receiving the user selection.

In one embodiment, the method for embedding links includes receiving, by a device, a data stream from a data server. The method also includes displaying, by the device, at least one object of the data stream on a display screen of the device. The method further includes activating, by the device, a link associated with a displayed object based on linking information. The linking information includes activation information and destination information. The activation information indicates a period of time when the link is activated. The destination information includes at least one of (i) address information that points to additional information on a remote server and (ii) launch information that specifies an application to be launched on the device. The method finally includes one of displaying, by the device, the additional information on the display screen and launching the application upon user selection of the activated link.

In one embodiment, the method activates the link in the area of the display screen included in the area information.

In one embodiment, the method further includes transmitting, by the device, location information of the device to the remote server associated with the additional information upon user selection of the activated link.

In one embodiment, the method further includes pausing, by the device, a display of the data stream upon user selection of the activated link.

In one embodiment, the method further includes un-pausing, by the device, the display of the data stream after the user performs at least one action.

In one embodiment, the method activates a plurality of links, and each link is associated with a different displayed object based on the linking information.

In one embodiment, user selection is received through a touch screen user interface.

In one embodiment, user selection is received through a pointing device user interface.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the embodiments, and wherein:

FIG. 1 illustrates a system for embedding links according to an embodiment;

FIG. 2 illustrates a processing unit according to an embodiment; and

FIG. 3 illustrates a method for reproducing data and activating links according to an embodiment.

### DETAILED DESCRIPTION OF EXAMPLE EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate form and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts) that may be implemented as program modules or functional processes including routines, programs, objects, components, data structures, etc., that perform particular tasks or implement particular abstract data types and may be implemented using existing hardware at existing elements (e.g., user devices such as computers, mobile phones, tablets, and/or smart television sets). Such existing hardware may include one or more Central Processing Units (CPUs), digital signal processors (DSPs), application-specific-integrated-circuits, field programmable gate arrays (FPGAs) computers or the like, which are specifically adapted to perform the functions of the example embodiments.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage”, “storage unit”, “memory” or “memory unit” may represent one or more devices for storing data, including read only memory (ROM), random access memory (RAM), magnetic RAM, core memory, magnetic disk storage mediums, optical storage mediums, flash memory devices and/or other tangible machine readable mediums for storing information.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in the storage unit and/or memory unit. When implemented in software, one or more processors will perform the necessary tasks.

As used herein, the term “device” may be synonymous to a user equipment, mobile user, access terminal, mobile terminal, user, subscriber, wireless terminal, terminal and/or remote station and may describe a remote user of wireless resources in a wireless communication network. Accordingly, a device may be a wireless phone, wireless equipped laptop, wireless equipped appliance, tablet computer, smart phone, television set and any other type of device capable of receiving data streams in a communication network and reproducing the video/audio content.

The embodiments provide an apparatus and/or method for embedding links. The apparatus may include a reproducing unit (e.g., an A/V player) that receives data streams from a data server such as a video-on-demand server and displays the video data (e.g., a movie or TV show) on a display screen of a user device. According to the example embodiments, the apparatus also includes a processing unit that activates one or more links associated with one or more displayed objects of the video. The links allow the user to view “additional information” that is relevant to the audio/video content being presented in that the links change with time and screen position throughout the reproduction. For instance, any object that is displayed on the display screen as part of a TV show or movie may have an embedded link that can display the referenced information. The referenced information could be an advertisement, biographical information on the actors, or other information that is related to the show or some object that is depicted in the show. Several examples are provided below.

Assuming that a user is watching a television show and that one scene shows a woman standing in a family room in front of a sofa, according to the embodiments, this scene includes an embedded link on the woman that would take the user to an online web store to purchase the clothing that the actress is wearing if the embedded link is selected. According to example embodiments, the user may select a link by, for example, touching the link on a display screen, or “clicking” on the link with a pointing device. The pointing device may be, for example, a mouse, touchpad, stylus, or joystick. Further, the user may select the sofa and the embedded link would allow the user to view the sofa at an online furniture store. Also, if the device is a mobile device (e.g. phone, tablet computer), according to the embodiments, the device provides the user's location to the web store such that the device can display the number of sofas of that model that are in stock at the store in the users' city. Further, if the user selects the opening credits, the embedded link displays further information on the actors or other related movies in which the actors played a role.

In addition, or alternatively, the activated links, when selected by a user, may launch an application on the device. In other words, any object that is displayed on the screen as part of a TV show or movie can have an embedded link that can launch another application that is relevant to the user and the audio/video content that is being presented. Examples of applications that could be launched include a media player, social networking application or a telephony application, for example.

The links of the example embodiments may be a link to any web page or application, and may occur at any point in the data stream (e.g., spatially and temporally). Further, the links may change spatially and temporally as the video plays.

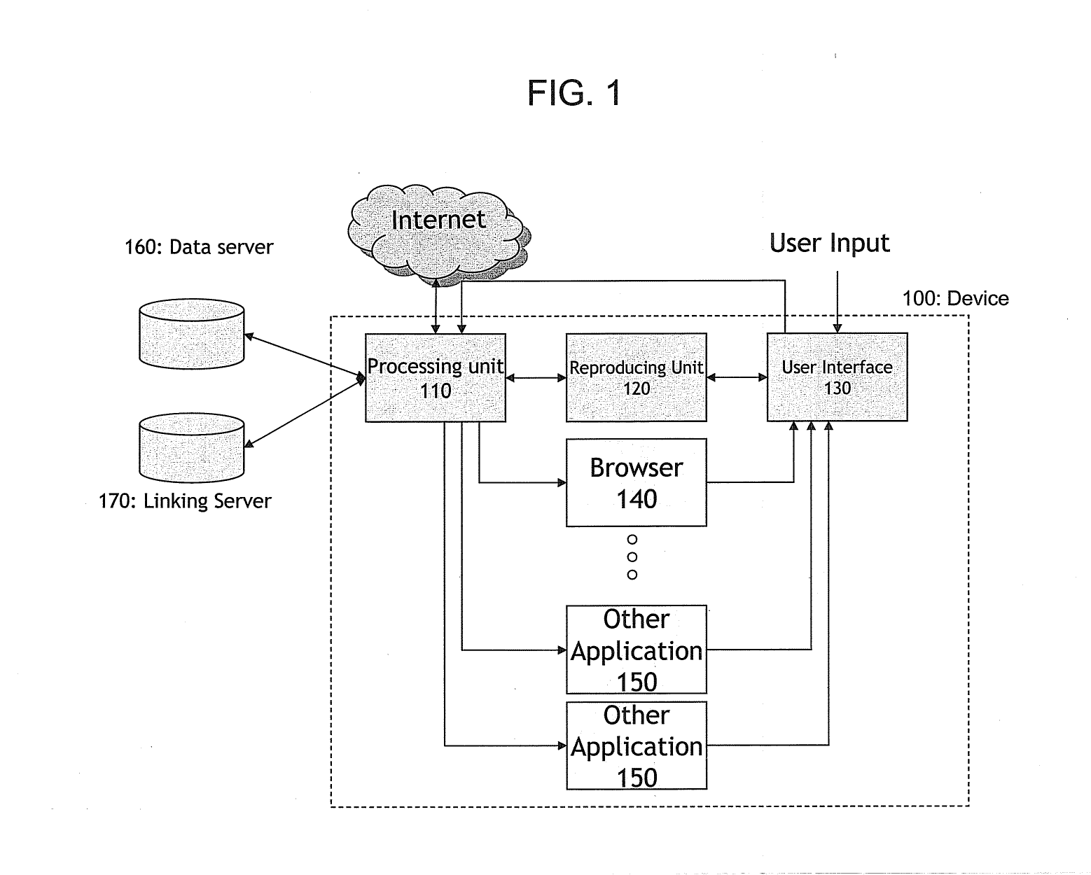

FIG. 1 illustrates a system for embedding links according to an embodiment. The system includes a data server 160 for storing and transmitting data streams (e.g., A/V streams), one or more devices 100 for receiving, processing and reproducing the content of the data streams, and a linking server 170 for storing linking information. The embodiments also encompass a situation in which the data server 160 and the linking server 170 are embodied into a single server. The linking information includes information that defines the links, as further described below. A data stream may be any type of media stream including, but not limited to, audio/visual (A/V) streams, and text/graphic streams. The data streams cover any number and type of codec such as MPEG or HTML (e.g., the example embodiments are codec-neutral). The system may include other well-known components.

The device 100 may be any type of device capable of receiving, processing and reproducing the transmitted data streams. For example, the device 100 may be a computer (e.g., personal or tablet), a mobile phone, or a television set. Further, the device 100 may be connected to the internet according to known methods. According to an embodiment, the device 100 includes a processing unit 110, a reproducing unit 120 (e.g., an A/V player), a browser application 140 for retrieving information from the Internet, and one or more other applications 150 such as a voice-over internet protocol (VoIP) telephony application, and/or a text message application, for example. The other applications 150 may further be any type of application known in the art capable of operating on a computer, mobile phone, or television set, such as, for example, image processing applications, word processing applications, social networking applications, and applications developed to execute on “smart TV” platforms. The device 100 also includes a user interface 130 to allow user interaction. The user interface 130 may be, for example, a touch screen or a pointing device. Further, the device 100 may include other components known in the art such as a demultiplexer and/or decoder for decoding the received data streams according to the respective coding standard.

The data server 160 may be any type of computer-based device for storing and delivering the data streams such as a video-on-demand (Vod) server. The data server 160 may be local to the device 100 or at a remote location. The data server 160 transmits the data streams to the device 100 through any type of communication interface such as wireless/wired internet connections, radio transmissions (e.g., broadcast or satellite), or cable connections, for example. The data server 160 may include at least one processor and a storage unit, as well as other components known in the art such as a multiplexer and/or encoder for encoding the data streams to be transmitted.

The linking server 170 may be any type of computer based device for storing linking information. The linking server 170 may include a storage unit for storing the linking information, and one or more processors. The linking server 170 may be local to the device 100 or at a remote location. The linking information may be stored on the linking server 170 in the form of one or more XML files, as further described below. The linking server 170 communicates with the processing unit 110 of the device 100 in order to obtain the necessary information for the implementation of the links in association with the displayed objects of the data streams. The linking server 170 communicates with the processing unit 110 through any type of communication interface such as wireless/wired Internet connections, radio transmissions (e.g., broadcast or satellite), or cable connections, for example. The communication interface between the processing unit 110 and the data server 160 may be the same or different from the communication interface between the processing unit 110 and the linking server 170.

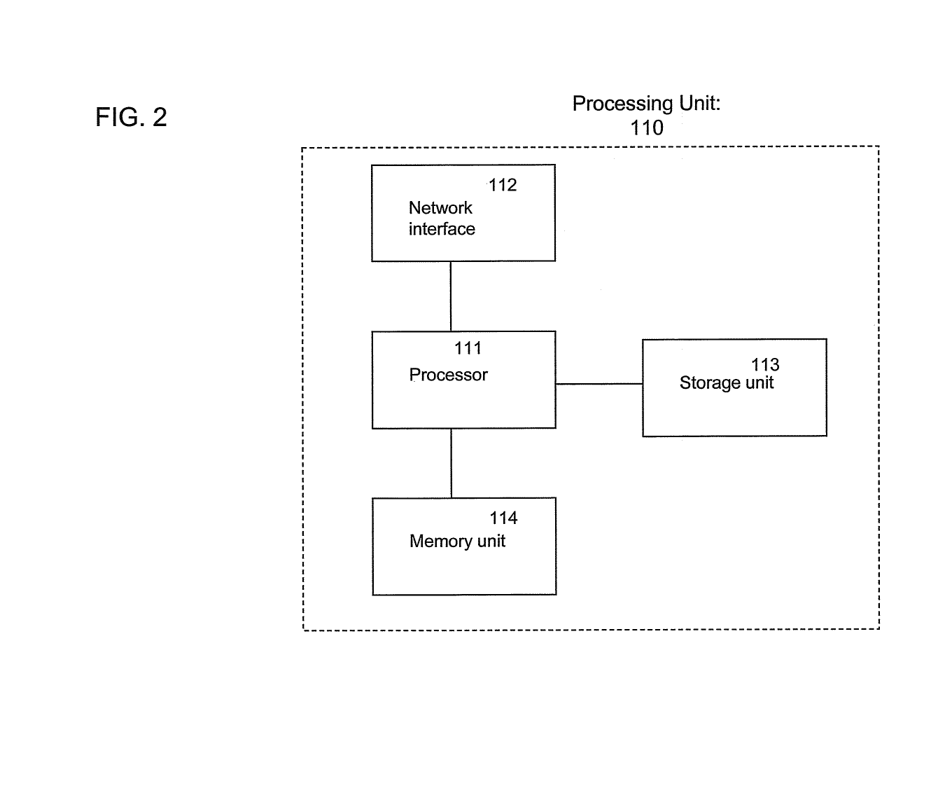

FIG. 2 illustrates the processing unit 110 according to an embodiment. The processing unit 110 may include one or more processors 111, a network interface 112, a storage unit 113, and a memory unit 114. The processing unit 110 may be used in conjunction with and/or may perform the functions of device 100, and may include any other well-known component.

The processors 111 are configured to control the overall operation of the processing unit 110 and/or device 100 by executing computer program instructions that define such operation. The computer program instructions may be stored in the storage unit 113 (e.g., magnetic disk, database, etc.) and loaded into the memory unit 114. Thus, applications for performing the herein-described method steps, such as receiving, activating, updating and/or launching are defined by the computer program instructions stored in the memory unit 114 and/or storage unit 113 and controlled by the processors 111 executing the computer program instructions. The processing unit 110 may also include one or more network interfaces 112 for communicating with other devices 100 and/or servers via the internet and/or communication network (e.g., a peer-to-peer network, etc.). The processors 111 may include one or more central processing units, read only memory (ROM) devices and/or random access memory (RAM) devices. One skilled in the art will recognize that an implementation of an actual processing unit could contain other components as well, and that the processing unit of FIG. 2 is a high-level representation of some of the components of such a processing unit for illustrative purposes.

Referring back to FIG. 1, the reproducing unit 120 is configured to receive one or more data streams from the data server 160 via the processing unit 110. For instance, the processing unit 110 may demodulate, decode and/or demultiplex the data streams according to any well-known methods. The reproducing unit 120 displays video content on a display screen of the device 100. The video content may include various visual objects. Further, the processing unit 110 is configured to load/receive the linking information from the linking server 170. According to an embodiment, the processing unit 110 activates one or more links associated with the displayed objects based on the linking information. Below is a non-limiting example of the linking information.

### Linking Information

<ads>

<link id=“1”>

<start>5000</start>
<stop>12000</stop>
<circle x=“300” y=“300” r=“200” >
<url>http://10.100.30.127/AdNumber1.html</url>
<desc>Coca-Cola Ad</desc>

<geo>yes</geo>

</link>

</ads>

The above syntax is a Document Type Definition (DTD) for embedding links according to an embodiment. However, the embodiments encompass any type of syntax or programming application that includes similar types of information. Although the above example provides one link, the embodiments encompass the situation in which the video clip includes multiple activated links. In such a situation, the linking information would include information on multiple links. In addition, the linking information may include multiple links that relate to the same type of additional information such that the advertisement, for example, may change in position and time.

The linking information includes numeric reference information that specifies an identification number associated with the link (<link id=“1”>), area information that defines an area on the display screen where the link is activated (<circle x=“300” y=“300” r=“200”>), activation information that indicates a period of time when the link is activated (<start>5000</start>, <stop>12000</stop>), destination information that defines the asset to be played, displayed, executed or referenced upon user selection of the activated link (<url>http://10.100.30.127/AdNumber1.html</url>), description information that specifies a textual description of the link (<desc>Coca-Cola Ad</desc>), and/or geographically sensitive information that indicates that the additional information is location sensitive (<geo>yes</geo>). The linking information may include one or more of the above described information. For example, if the link is not geographically sensitive, the linking information does not include the geographically sensitive information. Also, the numeric reference information may be utilized for sorting purposes. However, the numeric reference information may be not required for activation of the link. Further, the description information may be optional.

The area information defines an area on the display screen where the link is activated. In one embodiment, the area information may define a circle or rectangle on the display screen. However, the area information encompasses any type of shape defining where the link is activated. If the area information is defined by a circle, according to the DTD syntax, the area information includes the coordinates (x,y) on the display screen and the radius (r) of the circle. In other words, the coordinates (x,y) define the location of the center of the circle on the display screen, and the radius (r) indicates the size of the circle according to the DTD syntax. If the area information is defined by a rectangle, according to the DTD syntax, the area information includes the coordinates (x,y) on the display screen and the width (w) and height (h) of the rectangle. In other words, the coordinates (x,y) define the location of the top left corner of the rectangle on the display screen, and the height (h) and width (w) define the size of the rectangle according to the DTD syntax. According to the area information, the processing unit 110 activates the link on the display screen at the position indicated by the area information.

The activation information includes start information that indicates a start time when the link is activated and stop information that indicates a stop time when the link ceases to be activated. The start time and the stop time are in relation to the start of the video/audio clip. For example, in one embodiment, the start time and the stop time represent the time in milliseconds when the link is activated. The milliseconds are measured from the start of the video clip. For instance, if the start time is 5000 milliseconds and the stop time is 12000 milliseconds, as shown in the above example, the processing unit 120 activates the link 5000 milliseconds after the video clip starts reproducing and de-activates the link 12000 milliseconds after the video clip starts reproducing. However, the embodiments encompass any type of activation information that indicates a period of time when the link is activated. According to the activation information, the processing unit 110 activates the link on the display screen at the time specified by the activation information.

The destination information is any type of information that defines an asset (e.g., web page, application, etc.) to be played, displayed, executed or referenced. For example, the destination information may include at least one of (i) address information that points to the additional information such that the additional information is displayed on the display screen upon the user selection of the link and (ii) launch information that specifies an application to be launched on the device 100 upon the user selection of the link. For example, the address information may refer to a web page located on a remote server. The remote server may be different than or the same as the data server 160 that transmitted the data stream received by the reproducing unit 120. For example, the device 100 may receive video content from the video-on-demand server, and display information from a server not associated with this video-on-demand server upon user selection of the link. In other words, the address information may refer to a web page that is different from the video-on-demand server. In one embodiment, the destination address may be a URL address.

According to the embodiments, the processing unit 110 may be configured to update the additional information upon user selection of the link. For example, in one particular example, if the geographically sensitive information indicates that the additional information is location sensitive and the user selects the activated link, the processing unit 110 determines that the device 100 is moving (e.g., from the GPS receiver of the device 100), and transmit location information to the remote server indicated in the linking information. The remote server receives the location information and updates the additional information based on the location information. The device 100 displays the updated additional information on the display screen. In one embodiment, the geographically sensitive information may be information indicating whether the additional information is dependent upon the device's location.

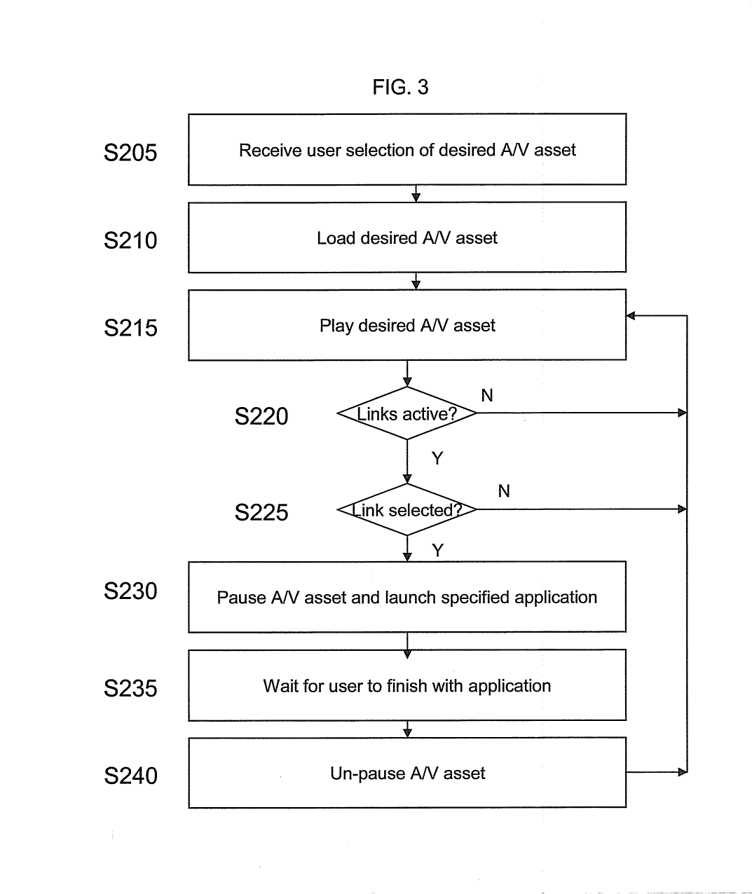

FIG. 3 illustrates a method for reproducing data and activating links according to an embodiment.

In step S205, the processing unit receives input from a user indicating the user-desired A/V asset including the data streams. In step S210, the processing unit 110 loads the desired A/V asset including the data streams and the linking information from the linking server 170. In step S215, the reproducing unit 120 reproduces the A/V asset. In addition, the processing unit 110 activates one or more links based on the linking information, as described above. In step 220, the processing unit 110 determines whether the links are activated. If the links are not activated, the processing unit 110 is configured to continue playing the desired A/V asset at step S215. If a link is activated, and the processing unit 130 receives an instruction in step S225 indicating that an activated link has been selected by the user the processing unit 110 is configured to pause the reproduction of the data stream in step 230 and to launch the application or display the additional information indicated in the linking information. If the user does not select any links, the processing unit 110 continues playing the desired A/V asset at step S215.

In step S235, the processing unit 110 waits to receive an action from the user that indicates that the user is finished viewing the additional information or using the launched application. In step S240, after receiving the user instruction, the processing unit 110 is configured to un-pause the reproduction of the data stream.

Variations of the example embodiments are not to be regarded as a departure from the spirit and scope of the example embodiments, and all such variations as would be apparent to one skilled in the art are intended to be included within the scope of this disclosure.

What is claimed:

1. An apparatus for embedding links, the apparatus comprising:
a reproducing unit configured to receive a data stream and display at least one object of the data stream on a display screen of a device; and
a processing unit configured to activate a link associated with a displayed object based on linking information, the linking information including activation information and destination information, the activation information indicating a period of time when the link is activated, the destination information including at least one of (i) address information that points to additional information on a remote server and (ii) launch information that specifies an application to be launched on the device,
the processing unit configured to one of display the additional information on the display screen and launch the application upon user selection of the activated link.

2. The apparatus of claim 1, wherein the remote server is different from a server that transmitted the data stream received by the reproducing unit.

3. The apparatus of claim 1, wherein the linking information further includes area information that defines an area on the display screen where the link is activated, and the processing unit is configured to activate the link in the area of the display screen included in the area information.

4. The apparatus of claim 1, wherein the activation information includes start information that indicates a start time when the link is activated and stop information that indicates a stop time when the link ceases to be activated.

5. The apparatus of claim 1, wherein the linking information includes geographically sensitive information that indicates that the additional information is location sensitive, wherein the processing unit is configured to transmit location information of the device to the remote server associated with the additional information upon user selection of the activated link.

6. The apparatus of claim 1, wherein, upon user selection of the activated link, the reproducing unit is configured to pause a display of the data stream.

7. The apparatus of claim 6, wherein the reproducing unit is configured to un-pause the display of the data stream after the user performs at least one action.

8. The apparatus of claim 1, wherein to processing unit is configured to activate a plurality of links, and each link is associated with a different displayed object based on the linking information.

9. The apparatus of claim 1, wherein the additional information is one of advertisement information, biographical information associated with the displayed object and information associated with a content of the data stream.

10. The apparatus of claim 1, further comprising a touch screen user interface for receiving the user selection.

11. The apparatus of claim 1, further comprising a pointing device user interface for receiving the user selection.

12. A method for embedding links, the method comprising:
receiving, by a device, a data stream from a data server;
displaying, by the device, at least one object of the data stream on a display screen of a device;
activating, by the device, a link associated with a displayed object based on linking information, the linking information including activation information and destination information, the activation information indicating a period of time when the link is activated, the destination information including at least one of (i) address information that points to additional information on a remote server and (ii) launch information that specifies an application to be launched on the device; and
one of displaying, by the device, the additional information on the display screen and launching the application upon user selection of the activated link.

13. The method of claim 12, wherein the linking information further includes area information that defines an area on the display screen where the link is activated, and the activating step activates the link in the area of the display screen included in the area information.

14. The method of claim 12, wherein the activation information includes start information that indicates a start time when the link is activated and stop information that indicates a stop time when the link ceases to be activated.

15. The method of claim 12, wherein the linking information includes geographically sensitive information that indicates that the additional information is location sensitive, and the method further includes:
transmitting, by the device, location information of the device to the remote server associated with the additional information upon user selection of the activated link.

16. The method of claim 12, further comprising:
pausing, by the device, a display of the data stream upon user selection of the activated link.

17. The method of claim 16, further comprising:
un-pausing, by the device, the display of the data stream after the user performs at least one action.

18. The method of claim 12, wherein the activating step activates a plurality of links, and each link is associated with a different displayed object based on the linking information.

19. The method of claim 12, wherein the additional information is one of advertisement information, biographical information associated with the displayed object and information associated with a content of the data stream.

20. The method of claim 12, wherein the user selection is received through one of a touch screen user interface and a pointing device user interface.
